(19) United States
(12) Patent Application Publication
(10) Pub. No.: US 2019/0003872 A1
(43) Pub. Date: Jan. 3, 2019

(54) Optical System, and Method for Identifying Fluid Through Said System

(71) Applicant: Robert Bosch Limitada, Campinas (BR)

(72) Inventor: Marcos Melo ARAUJO, Campinas (BR)

(21) Appl. No.: 16/066,702

(22) PCT Filed: Dec. 27, 2016
(86) PCT No.: PCT/BR2016/050354

§ 371 Date: Jun. 28, 2018

(30) Foreign Application Priority Data
Dec. 29, 2015 (BR) BR1020150328664

(51) Int. Cl. G01F 23/292; G01N 21/43

(52) U.S. Cl. CPC G01F 23/2927; G01N 2021/437; G01N 2021/434; G01N 21/431

(57) ABSTRACT

The present invention relates to the technological field of optical systems and refers to a device for identifying, at least one fluid, especially, fuel fluids in vehicle tanks. The device in question includes an optical guide having interaction surfaces and an emitter element emitting light beams and at least one receiving element of light beams. The information received from the receiving element includes the reflection emitted by interaction surfaces which are at the submersed region of the optical guide and indicates the type of fluid stored in the reservoir—for example: ethanol, gasoline or a mix of both. The interaction surfaces are inclined at different angles to provide total reflection for fluids with a different refractive index, including blends of fluids, to allow determination of the type of fluids according to the reflection by the interaction surfaces.

### FIELD OF THE INVENTION

The present invention refers to an optic system and respective method for identifying at least one type of fluid in a reservoir—more precisely, for fuels stored in motor vehicles tanks—which comprises several surfaces that refracts and/or reflects light beams making possible the acquisition of information, solely, based on optic properties observed on light interaction with the fluid and/or with the device. Specially, this invention aims to promote a simple, fast and precise solution to identify fuel fluids disposed on vehicle tanks or similar places, even in blends.

### BACKGROUND OF THE INVENTION

As it is known from technicians on the art, reservoirs of several types are used for storing several fluids, among them can be highlighted the motor vehicle tanks that are made for storing fuel. Still, as is it of common knowledge, for accompanying and guarantee the proper functioning of the vehicles and avoid disorders, it is necessary that the users of such vehicles constantly and precisely monitor the amount of remaining fuel on the tank, which is normally done by analogic or digital counters situated on the control panel of the vehicles. In this aspect, a variety of electronic, mechanic, ultrasonic and optic technologies, for example, can be used for monitoring and exhibiting the level of fluids, which are used in multiple systems, each one with its specific particularity and applicability.

Essentially, such systems should follow some basic requirements as: space economy, low weight, reliability and durability, and among the more common level meters for vehicle tanks, it is highlighted electronic sensors, floating systems, magnetic sensors and optic sensors.

One of the systems that uses optic technology and is broadly known on the state of the art is described in document U.S. Pat. No. 6,429,447 which comprises, basically, a body functioning as optical guide, an emitter element of light beam and a detector element. The basic functioning principles of this equipment relies on the refraction and reflection properties of a beam light according to the medium in which it propagates, as well as on the tilting angle of an interaction surface with light. More precisely, on the system of said document a light beam is reflected by staggered surfaces emersed on the fluid, and refracted by this surfaces when the same are immersed on this fluid, thus, is possible to measure the level of the same. Similar features device was described, also, on document U.S. Pat. No. 6,173,609, however both are proper just for measuring predetermined fluids with punctual and specific features—this is, are not effective for the measure of blend level.

In addition to the above context, the current technique faces an additional challenge generated by the development of vehicles equipped with so-called “flex fuel” technology, which are designed to operate with various types of fuels used alone or in mixtures—i.e. gasoline, alcohol and diesel—in any proportion that can be freely changed by users when fueling the vehicles. Thus, in addition to accurately measuring the fuel level, it is also necessary to identify which fuel fluids are stored inside the tank. In this respect, it is noted that the devices in the documents cited above are not suitable for vehicles equipped with “flex” technology.

Alternatively, the identification of the fuel in the tank of a vehicle can also be performed by a device substantially independent of the traditional level meters, which is known as a “lambda probe” or oxygen sensor, and operates by detecting the Constant oxygen content in the exhaust gases from the engine and compares it to the oxygen in the sampling air to subsequently send control information to the ECU (Electronic Control Unit) of the vehicle.

However, it should be noted that lambda probe identification only occurs after a certain period of engine operation since it is necessary to generate exhaust gases before the analysis can begin. The major problem of this application is therefore that the ECU is obliged to start the engine without necessarily knowing which fuel will be used for firing, and one of the consequences of this is a not uncommon difficulty in starting on the vehicle.

In order to provide a skillful apparatus for measuring the fuel level and at the same time identifying it, WO2014/153633 discloses an optical device comprising a guide body, a transmitter, an image projector and A photodetector, said guiding body comprising a series of inflection points which reflect the light when emanated, and refract the light when immersed in the fuel, wherein the fluid identification occurs by measuring the refractive index and analyzing the images from the Lighting. However, it should be noted that the above-identified fuel fluid identification is dependent upon an imaging projector and a photodetector—which makes the construction of this device significantly complex. Moreover, and even more serious, it is the limited accuracy of this device in the identification since it is performed basically by measuring the refractive index, which property can vary with the addition of solvents and other additives in the fuels.

Based on the foregoing, it is found that the current state of the art lacks practical, effective and reliable solutions in optical device for identification and measurement of level and identification of fluids stored mainly in fuel tanks of automotive vehicles.

### Objectives of the Invention

The present invention is basically aimed at solving the technical problem of the difficulties of identifying a fluid composed basically of a mixture of different types of fuels in reservoirs of tanks of motor vehicles.

Therefore, it is an object of the present invention to provide an optical system for identifying fluid in reservoirs intended, more specifically, for use in fuel tanks or related elements.

It is another object of the present invention to provide a method for identifying the type of fluid constant in the reservoir, even if said fluid is composed of a mixture of different fuels made with varying proportions.

It is also an object of the present invention to provide a system which operates by analyzing optical properties observed in the interaction between the fluid and/or the light beam device.

It is therefore also an object of the present invention to provide an optical system comprising, basically, a transmitter element, a sensor element, an optical guide and a prismatic system.

Particularly, it is an object of the present invention to provide an optical system comprising two or more surfaces patterns interacting with a light beam.

### SUMMARY OF THE INVENTION

The aforementioned objects are fully achieved by means of an optical system for identifying at least one type of fluid disposed in a reservoir or related location, more specifically for liquid and liquefied fluids, said system comprising at least one (6) of at least one light beam (5) and at least one light beam receiving element (7), said optical guide comprising a guide element (3) forming at least one optical path (4) for the light beams (5).

In a preferred embodiment of the invention, said optical guide (1) comprises a housing delimited by two upstanding cooperating vertical walls (14) with at least one substantially sloping face (100) defined by a plurality of steps, each Which is provided with a horizontal lower surface (11), the cooperation between the vertical walls (14) and the various lower surfaces (11) forming transverse prism compartments (2), wherein: the vertical walls (14) have edges (10) which can be as shown in the accompanying drawings, or are parallel to the substantially inclined face 100, which cooperates, respectively, with at least one light beam transmitter element (6) and at least one receiving element (7) of light beams (5); And the vertices formed between the vertical walls (14) and the lower surfaces (11) of the optical guide (1) comprise symmetrical and inclined interaction surfaces (3) based on at least one angle α—in which the surfaces Are inclined based on an angle β—, the interaction surfaces (3) being inclined on the basis of at least one angle β reflect the light beams (5) starting from the emitting element (6) for the element (7) in the region of the optical guide (1) that emerges in the fluid of said reservoir; The interacting surfaces (3) being inclined on the basis of at least one angle α reflect the light beams (5) from the emitter element (6) to the receiving element (7) in the region of the optical guide which is submerged in the Fluid from said reservoir; Wherein the information received by the receiving element (7) from the reflection emitted by the interaction surfaces (3) inclined on the basis of the at least one angle β of the region emerging from the optical guide (1) indicates the level of fluid stored in the reservoir; And wherein the information captured by the receiving element (7) from the reflection emitted by the interaction surfaces (3) inclined on the basis of the at least one angle α of the submerged region of the optical guide (1) indicates the type of fluid stored in the reservoir.

Preferably, said system comprises at least one system (8) cooperating with the light beam emitting element (6) and constituted by at least one collimating lens cooperating with or not with at least one diffuser.

Said optical guide (1) may optionally have at least one open region to enable, by means of a communicating vessel system, the inlet of the fluid contained in the reservoir within its internal compartment, as shown in the accompanying drawings.

Also, according to a preferred embodiment, the emitter element (6) emits a beam of light, or several light beams (5) simultaneously, continuously or at predetermined regular intervals, the emitter element (6) Comprises an emitter of at least one of light emitting diode (LED), laser and Oled, and may cooperate with a fiber optic system or the like.

The sensor element (7) is also preferably capable of detecting a plurality of light beams (5) simultaneously.

Preferably an interaction surface (3) inclined at an angle al indicates reflection of the light beam (5) immersed in a first type of fluid, while an interaction surface (3) inclined at an angle (A2) indicates reflection of the light beam (5) immersed in a second type of fluid and, similarly, an inclined interaction surface (3) based on an angle (α3) indicates reflection of the light beam (5) immersed in a third type of fluid or based on an angle (α4) consisting of a mixture of various types of fluid, the type of fluid may comprise at least one of gasoline, ethanol, diesel oil, natural gas, or any mixture thereof.

Further and preferably the interaction surfaces (3) of each of the steps of the substantially inclined face (100) are coplanar and define at least one optical path (4) for at least one light beam (5) between the element Emitter (6) and the receiving element (7), preferably the emitter element (6) and the light beam receiving element (7) are arranged in parallel in the upper portion (10) of the optical guide (1).

In addition, the receiving element (7) may comprise at least one of an electronic sensor of the type photocell, photodiode, phototransistor, LDR (light dependent resistor), photovoltaic cell, photoconductive, or other like light pickup means.

The invention also relates to a method of identifying fluid through an optical system comprising the steps of:
emitting at least one light beam (5) through an optical guide (1);
detecting at least part of the light beam (5) reflected by an interaction surface (3) in a submerged condition, and
identifying the or types of fluid stored in the reservoir as a function of the identification of the angle α of the interaction surfaces 3 which have had at least part of the light beam 5 reflected and read by the receiving element 7.

In the method in question, preferably the refractive index of at least one fluid in liquid or gaseous form defines the critical angle for reflection of the light beam (5) on a submerged interaction surface, beam of light (5) can be composed of visible light, infrared light or laser.

### BRIEF DESCRIPTION OF DRAWINGS

The present invention will be described in detail on the basis of the following figures, which are of a purely exemplary and non-limiting character, in which:

FIG. 1 shows schematically the optical system for identifying fluid in accordance with a preferred embodiment of the invention;

FIG. 2 schematically shows the fluid identification system, in particular highlighting the form of identification of a first type of fluid which, for example, may be fuel ethanol;

FIG. 3 schematically shows the fluid identification system highlighting the form of identification of a second type of fluid which, for example, may be gasoline;

FIG. 4 schematically shows the fluid identification system highlighting the form of identification of a third type of fluid which, for example, may be a mixture of ethanol and gasoline;

FIG. 5 shows a perspective view of a preferred embodiment of an optical guide of said system, which comprises a substantially prismatic body with several stepped interaction surfaces;

FIG. 6 shows an enlarged detail view of the embodiment shown in FIG. 5;

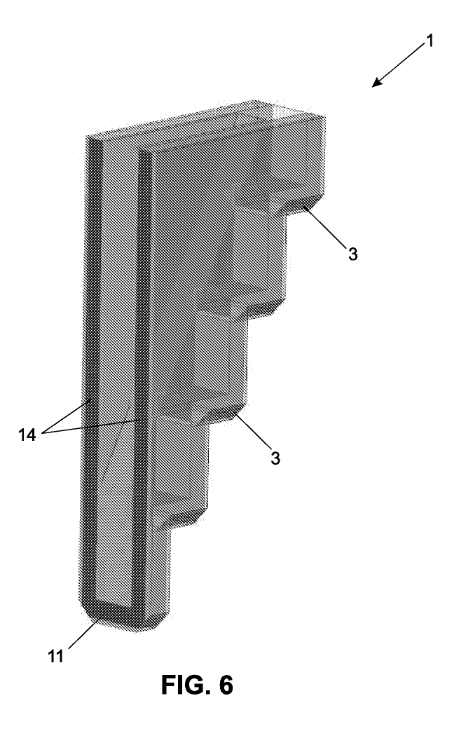

FIG. 7 shows the optical guide shown in FIG. 5, however highlighting beams of light emitted by the emitter element and reflected/refracted on interaction surfaces along said guide;

FIG. 8 shows another enlarged detail of the embodiment shown in FIG. 5, and

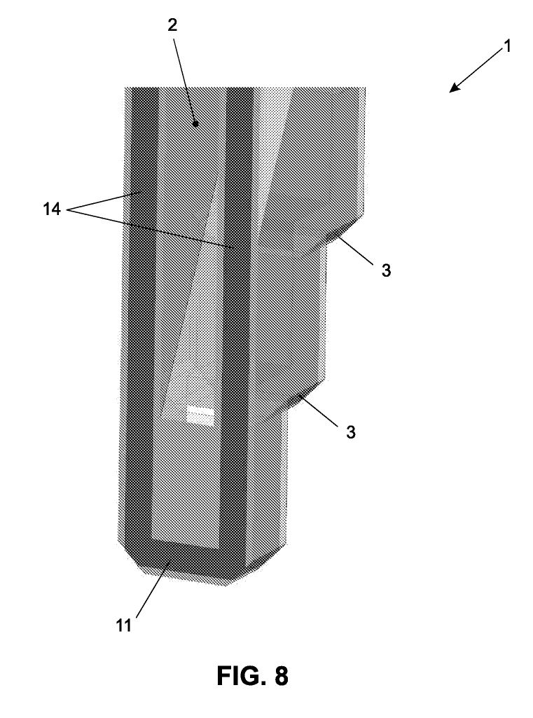

FIG. 9 shows a possible second embodiment for the optical system for identifying fluid of the present invention.

### DETAILED DESCRIPTION OF THE INVENTION

The object of the present invention will be more fully described and explained on the basis of the appended drawings, which are merely exemplary and non-limiting in character, since adaptations and modifications may be made without thereby departing from the scope of the claimed protection.

The present invention relates to an optical system for identifying a fluid in a reservoir, in particular for operating with combustible fluids in tanks of motor vehicles.

Initially, it is important to note that the present invention refers to “fluid” as the physical entity for which it is desired to identify the type, wherein volatile elements remaining in the medium are disregarded herein. In addition, it is valid to note that, for the present invention, an element is only considered “immersed” when immersed in direct contact with a fluid.

More precisely, and as shown in the appended Figures, the system in question basically comprises an emitter element 6 for emitting at least one light beam 5; At least one light beam receiver element 7; And at least one optical guide 1 in which the emitter elements 6 and light beam receiver 7 are installed.

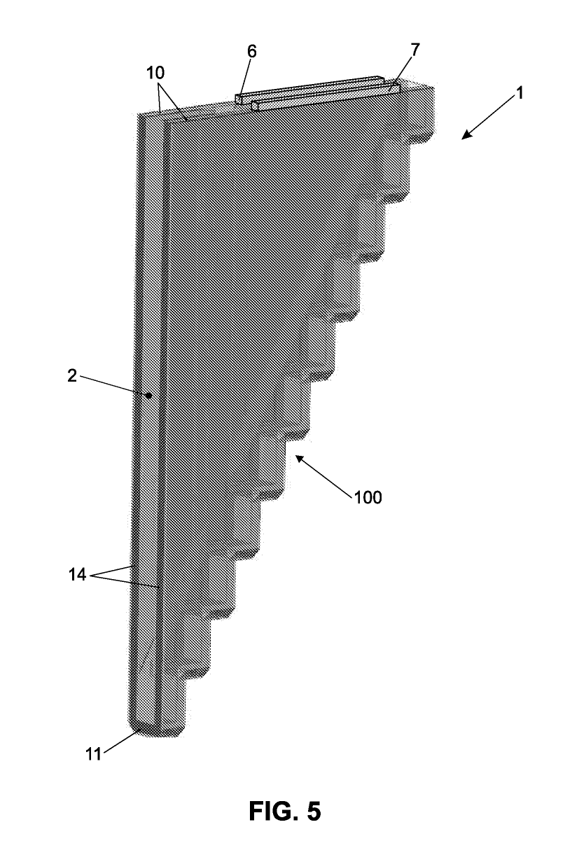

FIG. 5 shows that said optical guide 1 comprises a substantially triangular shaped body, having an upper face 10 and a substantially sloping face 100 defined by a plurality of steps, each provided with a lower surface 11 cooperating with vertical walls 14 which eventually form prismatic compartments 2 whose lower vertices have interaction surfaces 3 inclined at an angle α, said compartments 2 defining at least one optical path 4 for the light beam 5.

It is important to note that said optical guide 1 may optionally have an open region which can best be seen through the attached FIG. 5, wherein it is through said aperture that, through the communicating vessel system, the contained fluid in the reservoir enters the interior of the guide and it varies of height in its interior. Accordingly, depending on the fuel level within the tank of the vehicle, said prismatic compartment 2 can operate either underwater or submerged in fluid.

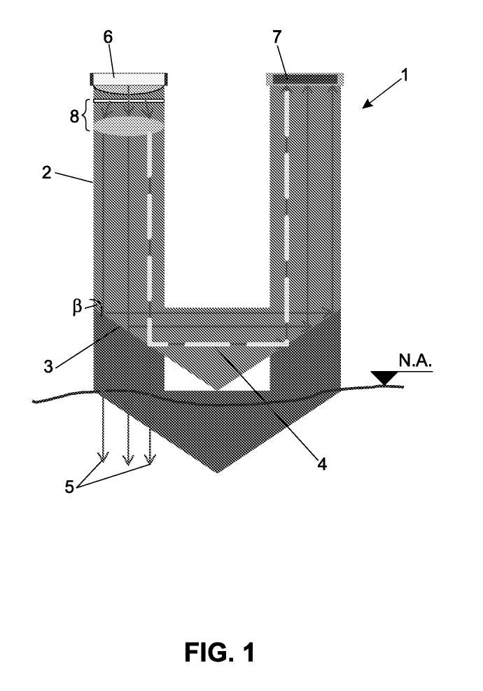

As can be seen in FIG. 1, the optical system of the present invention has the elementary functionality of allowing a light beam 5 to run through its interior so that reflection or refraction thereof can be captured and identified by the receiving element 7. Accordingly, said optical guide 1 must be produced in a material which allows the propagation of the light beam 5, but preventing or at least reducing any external interferences that may affect the accuracy of the system, whereby the optical guide 1 It may be to have its outer surfaces 13 enveloped or coated by reflecting or opaque elements. It should be noted that said material must necessarily withstand direct contact with combustible fluids, and among the materials capable of being used in the manufacture of said optical guide 1 it is possible to mention glass and polymeric materials. It should be further emphasized that the embodiment shown in FIG. 1 is exemplary only and not limiting, since the position of the system can be rotated at an angle ranging from 0 to 360 degrees without thereby escaping the scope of Protection claimed herein.

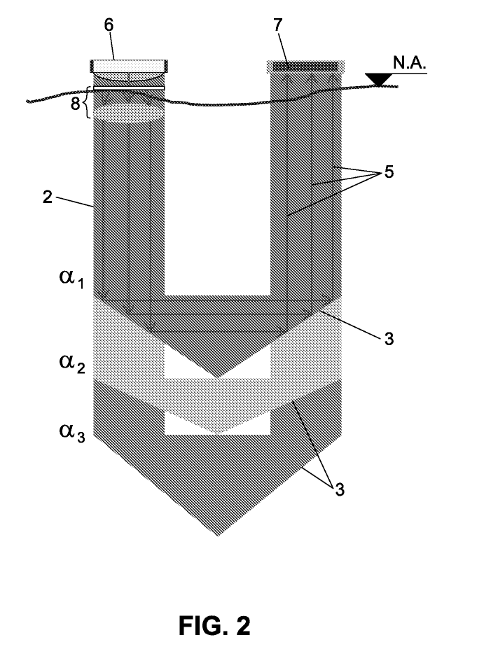

It should be noted that preferably the lower rungs of the optical guide—preferably three of them—will each have an inclination α1, α2 and α3 on the interaction surfaces as shown in the attached FIGS. 2 to 4, and such differentiated inclinations will allow the vehicle control devices to identify which type of fuel is being used—more specifically: alcohol, gasoline or a mixture of both, and the other steps may have a constant slope β, since they will be used exclusively to identify the presence or not Of fluid to determine the level of fuel stored within the reservoir.

As already mentioned and can be seen in FIGS. 1 to 4, at one of the upper edges 10 of the optical guide 1 is disposed the transmitting element 6 of light beams, wherein at the opposite upper edge 10 is located the corresponding element Receiver 7, preferably an optical system 8 made up of collimating lenses and diffusers are preferably disposed adjacent to the emitting element 6, which are intended to generate a rectangular light format for traveling the optical path 4. In a preferred embodiment, Emitter element 6 may be defined by an emitter or set of emitters (LED) (light emitting diode), laser, Oled and optionally be cooperating with a fiber optic system or the like.

Having clarified the constructive peculiarities of the level measurement and fluid identification system, its working principle will be detailed below.

As already mentioned, preferably the system of the present invention will be housed within the fuel tank of a vehicle, cooperating therewith by engagement, interference, or with the aid of any fastening elements, and once Properly installed, the system will operate in direct contact with the fluid under analysis, i.e., fuel, logically in whole or in part according to the level of fuel contained in it.

The operation of the system is effected by the emission of a light beam 5 originating from the emitter element 6, said light beam 5 propagating in a straight line and parallel to the longitudinal axis of the optical guide 1, more precisely to the light beam 5. Along the vertical wall 14 of the prismatic compartment 2, The correct orientation of the light beam 5 is ensured by the action of the collimating lens 8 cooperating or not with at least one diffuser.

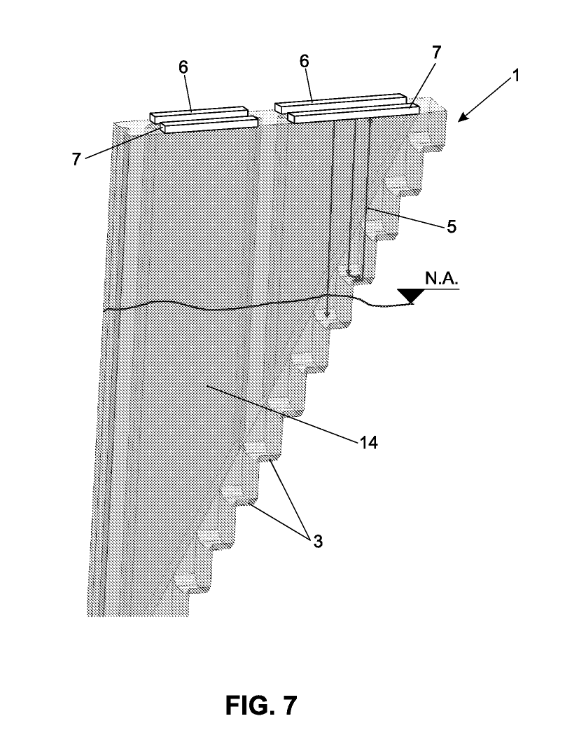

In a preferred embodiment of the present invention, and as can be seen in FIG. 7, a plurality of collinear light beams 5 are simultaneously emitted by the emitter element 6, these light beams 5 being distributed over at least Part of one of the upper edges 10 of the prismatic housing 2. It should be noted that the light beams 5 may be emitted either steadily or at regular intervals of time, in accordance with the need for application. In addition, it is possible that the emitter element emits only one beam of light, or multiple beams simultaneously.

When propagating along the vertical wall 14 of the prismatic housing 2, each light beam 5 impinges on an interaction surface 3 corresponding to the beam emitting position, the result of collision of the light beam 5 with Each interaction surface 3 depends substantially on two factors: the slope of each interaction surface 3 and the location of this surface 3 in relation to the fluid under analysis. At this point, it should again be emphasized that the device of the present invention comprises at least two patterns of interaction surfaces 3; A first pattern inclined at an angle α and a second pattern inclined at an angle β.

For the sake of clarity, again reference is made to FIG. 1 in which it can be seen that multiple light beams 5 are reflected as they collide with the interaction surfaces 3 that are emersed—that is, when the Level is below these surfaces. In turn, it is also possible to observe that when there is presence of fluid, the light beams 5 are not reflected by the interaction surfaces 3

Still while looking at FIG. 1, it is seen that a plurality of reflected light beams 5 define an optical path 4 (represented by a dashed line), defined by reflection of the light beams 5 on the two interaction surfaces 3, So that they return to the upper edge 10 of the optical guide 1, more precisely at the point where the light beam receiver element 7 is arranged.

It is important to note that the light beams 5 are only reflected by interacting surfaces 3 which are emersed because they have an inclination angle α. This specific slope corresponds to the critical angle of total reflection of the light beam 5 when it is emitted in accordance with the aforementioned conditions and propagates substantially in the air. It is also worth noting that the interaction surfaces 3 of the region emanating from the optical guide 1 will reflect the light beams 5 even though there is presence of volatile elements in the air. Thus, it is clear that the basic principle for level measurement according to the system of the present invention lies in the analysis of the light beams 5 which, once reflected by the interaction surfaces, reach the receiving element 7.

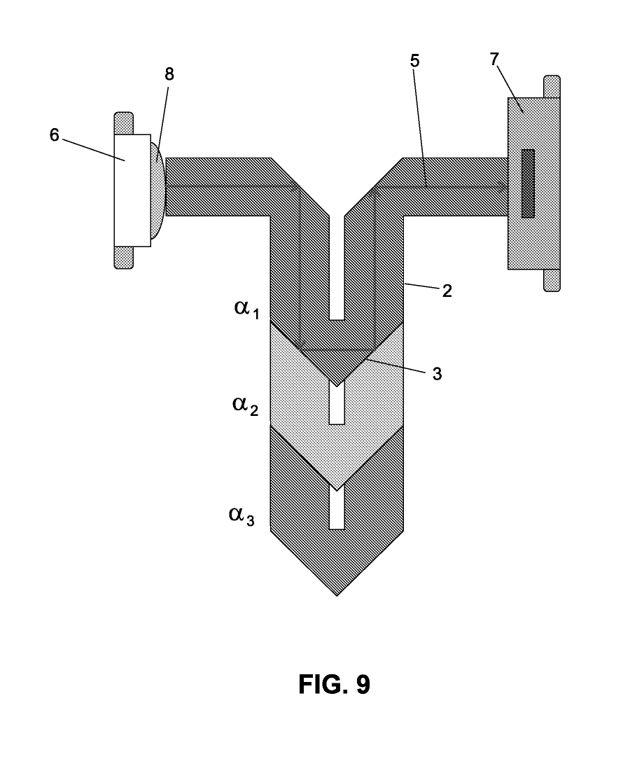

It is furthermore to be understood that the receiver element 7—which may comprise an electronic sensor of the type photocell, photodiode, phototransistor, LDR (light dependent resistor), photovoltaic cell, photoconductive, or other like light pickup means—is defined by a Capable of receiving light beams 5 and interpreting them. More precisely, the receiving element 7 is able to know from which of the steps of the inclined surface 100 belong the interaction surfaces 3 in which the light beam 5 has been reflected and, in this way, determine from the exact position of the fluid level in analysis. It should be further noted that the receiving member can be located in any position of an optical system such as that shown in the attached FIG. 9, provided it is capable of picking up the light beam 5 reflected by the interaction surfaces 3.

Identification of the fluid type by the system of the present invention occurs in a manner analogous to level measurement; However, it is necessary for (i) that there be several interaction surfaces 3, each inclined at an angle a corresponding to the type of fuel that can be used in the vehicle, and that (ii) such interaction surfaces are arranged at locations in which will preferably always have stored fuel (submerged region)—that is, in the submerged regions most of the time, which correspond to the lowermost region of the optical guide 1 and, consequently, the fuel tank or tank. FIGS. 2,3 and 4 exemplify such a condition.

It is emphasized that in air the light beams 5 are always reflected by the interacting surfaces inclined at an angle β, however when the light beams 5 traverse a liquid medium, the refraction characteristics vary according to the type of fluid, so that each fuel that can be used in the vehicle has its critical angle α of predetermined reflection so that several interaction surfaces 3, each with the angle α corresponding to a type of fuel that can be identified, are formed.

In this way, the invention allows the identification of the fluid, even in mixtures. In particular, the present invention provides a skillful system for identifying and, consequently, differentiating fuel fluids stored in tanks of flex type vehicles.

Referring to FIG. 2, it is seen that the light beam 5 has been reflected by an interaction surface 3 having an inclination angle α1. In particular, α1 represents the total reflection angle of a light beam 5 when it propagates in fuel ethanol.

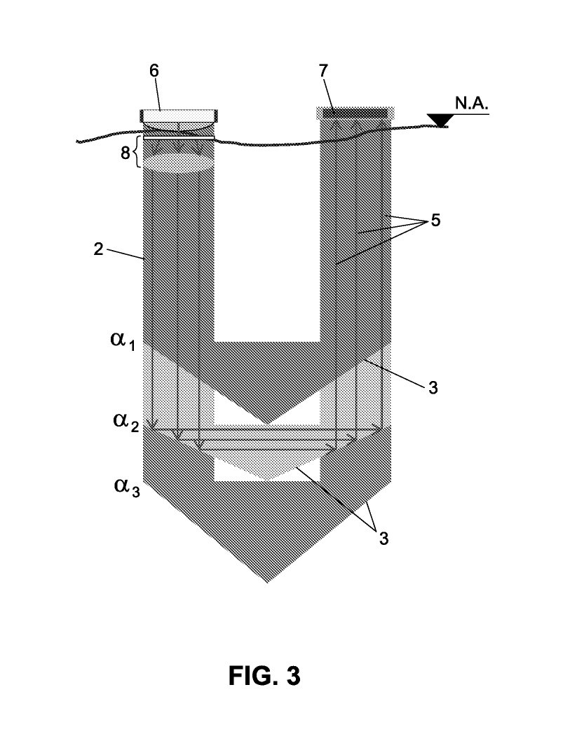

Similarly, upon observing FIG. 3, it is seen that the light beam 5 has been reflected by an interaction surface 3 having an inclination angle α2, where α2 represents the total reflection angle of the beam of light. Light 5 when it spreads in gasoline.

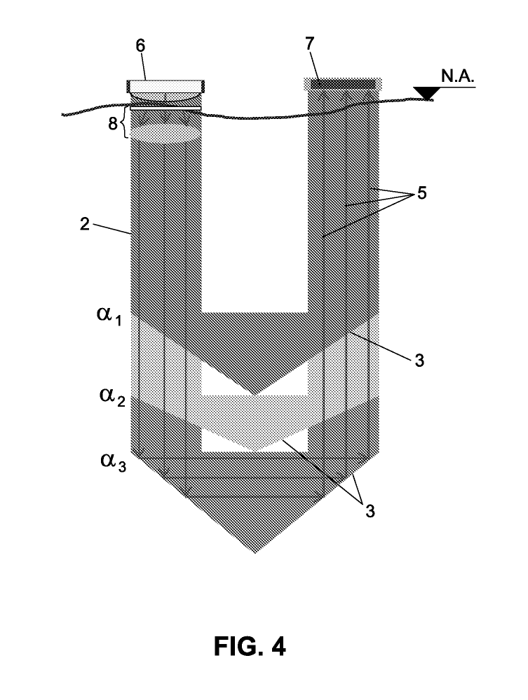

Finally, referring to FIG. 4, it is seen that the light beam 5 has been reflected by an interaction surface 3 having an inclination angle α3, which represents the total reflection angle of the light beam 5 when the beam Even spreads on other fuel. Those skilled in the art will obviously realize that it is possible to allow simultaneous identification of any other types of fluids as required, provided that the critical angles of reflection are determined and known each time. It is also important to note that such fluid type identification will be possible regardless of the mixing ratio being used.

Thus, and briefly, it is noted that the prismatic compartment 2 of the optical guide 1 is developed to comprise a plurality of interaction surfaces 3, each of which comprises a specific α-slope defined to reflect the light beam 5 In a given condition, the definition of these angles α being obviously dependent on the refractive index of each substance or propagation medium.

In addition to the above disclosed device, the present invention also discloses a method for level measurement and identification of at least one fluid stored in a reservoir—especially fuel in tanks of automotive vehicles. The method in question comprising the steps of: (i) emitting at least one light beam 5 through an optical guide 1; (Ii) detecting at least part of the reflected light beam 5 through an interaction surface 3 in an emanating condition (without the presence of fluid); (Iii) detecting at least part of the light beam 5 reflected by an interaction surface 3 in submerged condition; (Iv) identifying the position at which at least part of the light beam 5 has been reflected on at least one interaction surface 3 in an emerging condition; (V) identifying the or types of fluid stored in the reservoir as a function of the identification of the angle α of the interaction surfaces 3 which have had at least part of the light beam 5 reflected and read by the receiving element 7.

In particular, according to a preferred embodiment of the method in question, the refractive index of at least one fluid defines the critical angle for reflection of the light beam 5 on an interaction surface 3 in submerged condition. More precisely, the propagation of the light beam 5 by the fluid under analysis causes a deviation in the light beam 5 hence the refractive index of this substance. However, each interaction surface 3 in the emitted condition is designed to have an inclination angle β which allows the total reflection of the light beam 5 even considering this deviation.

Among others, it is an advantage of the present method, in particular, the identification of a fuel fluid, even in a mixture before the fuel is burned in the engine of a vehicle. In this way, the automobile control system can be informed about which fuel will power the electronic injection system before starting, a fact that is especially important for flex-type vehicles.

It is also worth noting that the light beam 5 may be composed of visible light, infrared light, laser or any type of radiation suitable for the application. Still, it is important to note that, for purposes of accuracy of the above reported method, it is important that the light beam 5 be collimated by a collimator lens.

Based on the foregoing description, it is apparent that the object of the present invention solves the drawbacks of the present state of the art in an unprecedented, practical and extremely effective manner.

1. Optic system for identifying at least one type of fluid, in which said system comprises at least on optical guide cooperating with at least one emitter element of at least one light beam and at least one receiving element of light beams, in which said optical guide comprises a recipient having interaction surfaces conforming at least one optic path for the light beams, characterized in that:
said interaction surfaces are inclined based on at least one angle α;
interaction surfaces inclined based to at least one α angle reflecting the light beams coming from the emitter element for the receiving element on the optical guide region that is submerse on the fluid of said reservoir; and
the information get from the receiving element coming from the reflection emitted by the interaction surfaces inclined based on at least one angle α of the submerse region of the optical guide indicating the type of fluid.

2. System, according to claim 1, characterized in that comprises at least one optic system cooperating with the emitter element of light beams, said optic system constituted by at least one collimator lenses cooperating or not with at least one diffusor.

3. System, according to claim 1, characterized in that the emitter element output a light beam, or several light beams simultaneously.

4. System, according to claim 1, characterized in that the emitter element output a single light beam, or a plurality of light beams continuously.

5. System, according to claim 1, characterized in that the emitter element output a single light beam, or a plurality of light beams in predetermined regular intervals.

6. System, according to claim 1, characterized in that the sensor element detects a plurality of light beams simultaneously.

7. System, according to claim 1, characterized in that the emitter element comprises an emitter of at least one among LED (light emitting diode), lased and Oled.

8. System, according to claim 1, characterized in that the emitter element cooperates with an optic fiber system or the like.

9. System, according to claim 1, characterized in that an interaction surface inclined based on an angle indicated light beam reflection immerse on a first type of fluid.

10. System, according to claim 1, characterized in that an interaction surface inclined based on an angle indicates light beam reflection immerse on a second type of fluid.

11. System, according to claim 1, characterized in that an interaction surface inclined based on an angle indicates light beam reflection immerse on a third type of fluid.

12. System, according to claim 1, characterized in that an interaction surface inclined based on an angle indicates light beam reflection immerse on a type of fluid having a blend of several types of fluid.

13. System, according to claim 8, characterized in that the type of fluid comprises at least one among gasoline, ethanol, diesel, vehicles natural gas or a blend of them.

14. System, according to claim 1, characterized in that the interaction surfaces of each one of the steps of the substantially inclined face are coplanar and define at least one optic path for the at least one light beam between the emitter element and the receiving element.

15. System, according to claim 1, characterized in that the emitter element and the receiving element of light beams are disposed parallel on the optical guide.

16. System, according to claim 1, characterized in that the receiving element comprises at least one among the photocell type electronic sensor, photodiode, phototransistor, LDR (light dependent resistor), photovoltaic cell, photoconductor, or other light capturing means.

17. Method for identifying fluid, characterized in that it uses an optic system according to claim 1 and comprises the following steps:
output at least one light beam by the optical guide;
detect at least part of the light beam reflected by an interaction surface in submerse condition; and
identify the types of fluid stored by the identification of angle α of interaction surfaces that had at least part of the light beam reflected and read by the receiving element.

18. Method, according to claim 18, characterized in that the refraction index of, at least, one fluid in liquid or gas form defines the critical angle for light beam reflection in an interaction surface in submerse condition.

19. Method, according to claim 18, characterized in that the light beam is composed of visible light, infrared light or any radiation spectrum.
